(19) United States
(12) Patent Application Publication
(10) Pub. No.: US 2013/0070408 A1
(43) Pub. Date: Mar. 21, 2013

(54) Portable computer operation station

(71) Applicant: Haitao Shen, Shenzhen (CN)

(72) Inventor: Haitao Shen, Shenzhen (CN)

(21) Appl. No.: 13/200,178

(22) Filed: Sep. 19, 2011

(51) Int. Cl. G06F 1/20; G06F 1/16

(52) U.S. Cl. 361/679.27

(57) ABSTRACT

A portable computer operation station is adapted for supporting a portable computer, wherein the portable computer operation station includes an input device and a supporting frame foldably coupled with the input device to move between a folded position and an operation position. At the folded position, the supporting frame is folded to overlap on the input device to form a compact planar structure, and at the operation position, the supporting frame is folded at an inclination angle with respect to the input device for inclinedly supporting a main panel of the portable computer at the supporting frame so as to elevate a display panel of the portable computer and to offer an extended length between the display panel of the portable computer and the input device.

### BACKGROUND OF THE PRESENT INVENTION

1. Field of Invention

The present invention relates to a portable computer, and more particular to a portable computer operation station, which is adapted for the portable computer such as notebook or tablet being resided thereon to offer a comfortable and ergonomically healthy environment for the user to use the portable computer.

2. Description of Related Arts

When buying a computer, the most popular question asked is “Should I buy a notebook or desktop computer?” Desktop computer is typically resided on a desk and generally comprises a tower, a screen monitor, and an input device such as keyboard and mouse. Desktop computer offers better ergonomics since the screen monitor can be selectively elevated at a desired position on the desk for enhancing the viewability of the screen monitor and the keyboard can be selectively adjusted for ergonomically fitting the hand position of the user.

However, desktop computer is tied to one place and requires a relatively large desk space for monitor and input device residing thereon. In addition, the user is unable to carry the desktop computer and to use the desktop anywhere.

Notebook computer generally comprises a screen panel pivotally coupled with an input panel, wherein the screen panel is adapted to be pivotally flipped on the input panel to form a compact structure. Likewise, notebook computer is easy to pack up and can be used anywhere. In recent years, the key specifications, such as CPU, RAM, graphics adapter, and hard drive, of the notebook computer are almost the same as the key specifications on desktop computer. Therefore, most users prefer having a notebook computer at home since the almost everything can be done on the notebook computer that it can be do on the desktop computer and the price of the notebook computer is almost the same as the price of the desktop computer.

However, it is impossible to set up the notebook computer in such an ergonomic way. Accordingly, the input panel is laid flat on the desk surface, wherein the input device, including touchpad and keyboard, is located on the top side of the input panel. Therefore, the input device is orientated in horizontal level such that the wrists/hands of the user will have not support. In other words, the wrists of the user will be twisted in a non-neutral position when the fingers are placed on the keys. Such typing posture will increase the workload on the wrists, forearms and shoulders of the user. In addition, the screen panel can only be adjusted its tilted angle with respect to the input panel. To avoid neck fatigue and headaches, the screen panel should be adjusted to eyelevel and about an arm length from the user. A proper screen position is that the user should be looking slightly downward to view the screen on the screen panel. However, the structural configuration of the notebook computer does not allow the user to adjust the keyboard position and/or the screen position.

On the other hand, desktop computer can be set up as a workspace to offer a comfortable and ergonomically safe environment. The screen monitor of the desktop computer can be selectively elevated at a desired position on the desk to eyelevel of the user and about an arm length from the user. At the mean time, the keyboard of the desktop computer can be adjusted that the top of the keyboard is slightly sloped away to the bottom so that the wrists of the user are in a neutral position when the fingers are placed on the keys. Setting a workspace in this ergonomic way will minimize strain on the eyes, neck, back, wrists as well as hands of the user.

### SUMMARY OF THE PRESENT INVENTION

The invention is advantageous in that it provides a portable computer operation station, which is adapted for the portable computer being resided thereon to offer a comfortable and ergonomically healthy environment for the user to use the portable computer.

Another advantage of the invention is to a portable computer operation station, which is designed with a unique structural configuration to combine the features of a conventional notebook computer and a conventional desktop computer to offer better ergonomics as the conventional desktop computer does and to provide more freedom to use anywhere as the conventional notebook computer does.

Another advantage of the invention is to a portable computer operation station, wherein the screen panel of the portable computer such as a notebook or a tablet is selectively elevated to an eyelevel of the user for enhancing the viewability of the screen panel.

Another advantage of the invention is to a portable computer operation station, wherein when the input device is moved away in responsive to the screen panel, the screen panel is kept in an arm length from the user to offer a comfortable and ergonomically healthy environment for the user.

Another advantage of the invention is to a portable computer operation station, wherein the input device is supported at sloped downward manner for ergonomically fitting the hand position of the user in a neutral position while the fingers of the user are placed on the keys.

Another advantage of the invention is to a portable computer operation station, wherein the computer peripheral link is arranged for operatively linking the portable computer, such as a notebook or a tablet, when the portable computer is supported at the portable computer operation station to operatively connect with different peripheral computer devices, such as projector, printer, speakers, DVD or CD reader, SD or other smart card reader, external hard drive, DSL cable, and etc., so as to expand the utility and connectivity of the portable computer through the portable computer operation station.

Another advantage of the invention is to a portable computer operation station, which can enhance the heat dissipation of the portable computer when the portable computer is supported at the portable computer operation station.

Another advantage of the invention is to a portable computer operation station, wherein the set up of the present invention is simple and easy by folding the input device out of the supporting frame and folding the supporting leg out of the supporting frame.

Another advantage of the invention is to a portable computer operation station, which is adapted to incorporate with any size of portable computer for offering a comfortable and ergonomically safe environment for the user to use the portable computer.

Another advantage of the invention is to a portable computer operation station, wherein the workstation can be an individual standalone unit to incorporate with an existing tablet computer by detachably attaching tablet to the portable computer operation station.

Another advantage of the invention is to a portable computer operation station, which does not involve complicated or expensive mechanical components so as to minimize the manufacturing cost of the present invention.

Another advantage of the invention is to provide a portable computer operation station, wherein no expensive or complicated structure is required to employ in the present invention in order to achieve the above mentioned objects. Therefore, the present invention successfully provides an economic and efficient solution for providing a comfortable and ergonomically safe environment for the user.

Additional advantages and features of the invention will become apparent from the description which follows, and may be realized by means of the instrumentalities and combinations particular point out in the appended claims.

According to the present invention, the foregoing and other objects and advantages are attained by a portable computer operation station for a portable computer, such as a notebook, having a main panel and a display panel, wherein the portable computer operation station comprises an input device adapted for resting on a working surface, and a supporting frame foldably coupled with the input device to move between a folded position and an operation position.

Accordingly, at the folded position, the supporting frame is folded to overlap on the input device to form a compact planar structure, and at the operation position, the supporting frame is folded at an inclination angle with respect to the input device for inclinedly supporting the main panel of the portable computer at the supporting frame so as to elevate the display panel of the portable computer and to offer an extended length between the display panel of the portable computer and the input device.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a portable computer operation station for a portable computer according to a first preferred embodiment of the present invention, illustrating the display panel of the portable computer being elevated and being located away from the input device.

FIG. 2 is a perspective view of the portable computer operation station at the operation position according to the above first preferred embodiment of the present invention.

FIG. 3 is a perspective view of the portable computer operation station at the folded position according to the above first preferred embodiment of the present invention.

FIG. 4 is a side view of the portable computer operation station according to the above first preferred embodiment of the present invention, illustrating the portable computer being supported by the portable computer operation station.

FIG. 5 is a perspective view of a portable computer operation station at the operation position according to a second preferred embodiment of the present invention.

FIG. 6 is a side view of the portable computer operation station according to the above second preferred embodiment of the present invention, illustrating the portable computer being supported by the portable operation station.

FIG. 7 is a perspective view of the portable computer operation station at the folded position according to the above second preferred embodiment of the present invention.

FIG. 8 is a perspective view of the portable computer operation station at the operation position according to a third preferred embodiment of the present invention.

FIG. 9 is a side view of the portable computer operation station according to the above third preferred embodiment of the present invention, illustrating the portable computer being supported by the portable operation station.

FIG. 10 is a perspective view of the portable computer operation station at the folded position according to the above third preferred embodiment of the present invention.

FIG. 11 is a perspective view of a portable computer operation station according to a fourth preferred embodiment of the present invention.

FIG. 12 is a front perspective view of a portable computer operation station according to a fifth preferred embodiment of the present invention.

FIG. 13 is a rear perspective view of a portable computer operation station according to the above fifth preferred embodiment of the present invention.

### DETAILED DESCRIPTION OF THE PREFERRED EMBODIMENT

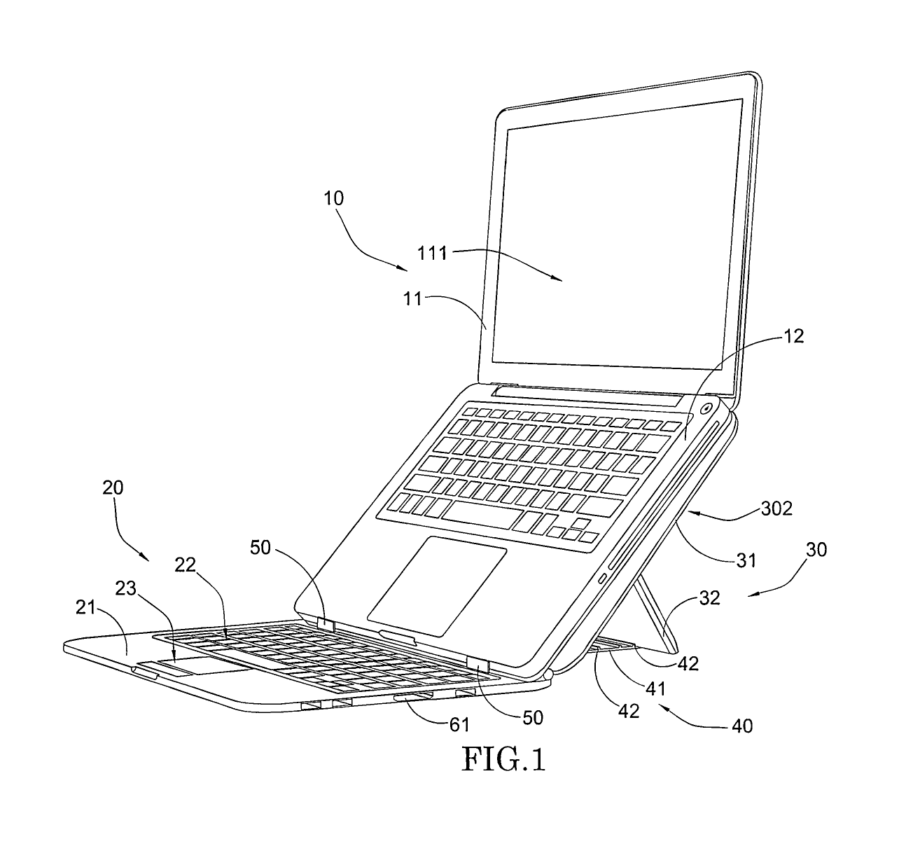

Referring to FIGS. 1 to 4 of the drawings, a portable computer operation station for a portable computer, such as a notebook computer, according to a first preferred embodiment of the present invention is illustrated, wherein the portable computer operation station is adapted for the user of the notebook computer to implement the portable computer operation station as a good ergonomic workstation layout.

Accordingly, because of the inherently problem of the portable computer, embodied as a notebook computer, it is so difficult to design a good ergonomic workstation for the portable computer 10. Generally, the portable computer 10 comprises a display panel 11 defining a screen area 111 thereat, and a main panel 12 foldably coupled with the display panel 11 edge-to-edge, wherein keyboard and pointer device are provided at the main panel 12. Therefore, when the display panel 11 is at a comfortable height, the main panel 12 is not, and vice versa. The present invention is configured to be a good ergonomic workstation that the display panel 11 is elevated at a comfortable height corresponding to the user's eye level and is kept with an arm length from the user while the user has no need to lift his or her hands to type on the keyboard of the main panel 12. The portable computer desktop operation station of the present invention is also designed for ergonomically fitting the hand position of the user in a neutral position while the fingers of the user are placed on the keys.

Accordingly, the portable computer operation station, which is embodied as a portable workstation, comprises an input device 20 adapted for resting on a working surface, and a supporting frame 30 foldably coupled with the input device 20 to move between a folded position and an operation position.

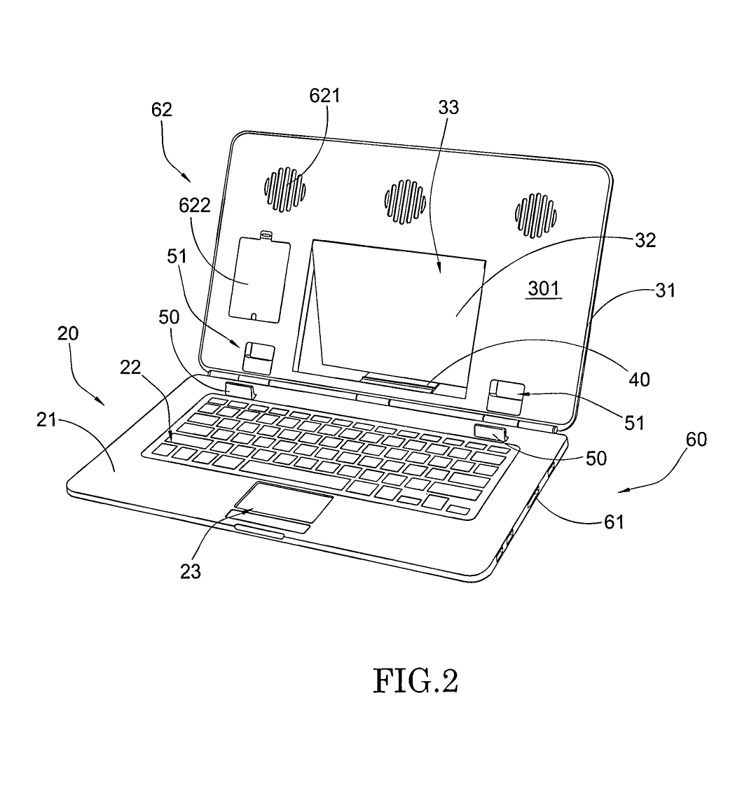

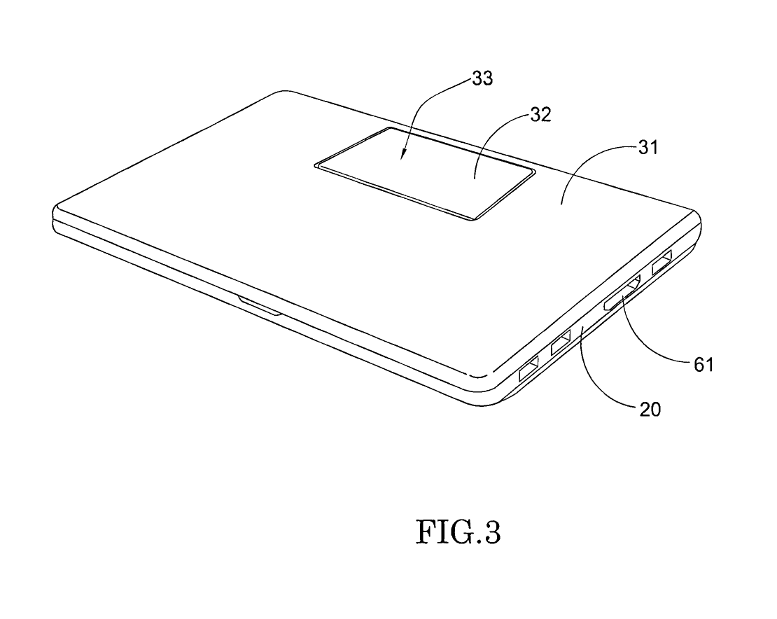

Accordingly, at the folded position, as shown in FIG. 3, the supporting frame 30 is folded to overlap on the input device 20 to form a compact planar structure, and at the operation position, as shown in FIGS. 1 and 2, the supporting frame 30 is folded at an inclination angle with respect to the input device 20 for inclinedly supporting the main panel 12 of the portable computer 10 at the supporting frame 30 so as to elevate the display panel 11 of the portable computer 10 and to offer an extended length between the display panel 11 of the portable computer 10 and the input device 20, so that the user can view the elevated display panel 11 at eye level while typing with the input device 20 provided by the portable computer operation station of the present invention comfortably at arm level.

As shown in FIG. 2, the input device 20 comprises an input panel 21 defining a keyboard 22 and a pointing device 23 thereon, wherein the input device 20 is can be connected to the portable computer 10 via USB cable or preferably connected to the portable computer 10 in a wireless manner. Preferably, the input device 20 is operatively linked to the portable computer 10 through wireless connection such as “Bluetooth” or infrared connection. It is appreciated that the input device 20 is operatively linked to the portable computer 10 through wire connection such as USB cable connection.

The input panel 21 is laid flat on the working surface such that the bottom side of the input device 20 is rested on the working surface while the top side of the input device 20 forms a top input side where the keyboard 22 and the pointing device 23 located.

The supporting frame 30 has a bottom edge pivotally coupled with a rear edge of the input device 20, wherein the supporting frame 30 has a front supporting side 301 and a rear side 302. When the supporting frame 30 is pivotally folded at the folded position, the supporting side 301 of the supporting frame 30 is overlapped on the top input side of the input device 20. When the supporting frame 30 is pivotally folded at the operation position, the supporting frame 30 is upwardly and rearwardly folded from the input device 20 and is inclinedly extended from the input device 20 at the inclination angle. Accordingly, the inclination angle is an obtuse angle that the supporting frame 30 is pivotally folded with a range between 90° to 180°. Preferably, the inclination angle is set at 120° between the input device 20 and the supporting frame 30.

The supporting frame 30 comprises a supporting panel 31 pivotally coupled with the input device 20 edge-to-edge, and a folding leg 32 pivotally coupled with the supporting panel 31 and arranged in such a manner that when the supporting panel 31 is pivotally and upwardly folded from the input device 20 for inclinedly supporting the main panel 12 of the portable computer 10, the folding leg 32 is pivotally and outwardly folded for standing at the working surface to retain the supporting panel 31 at the inclination angle.

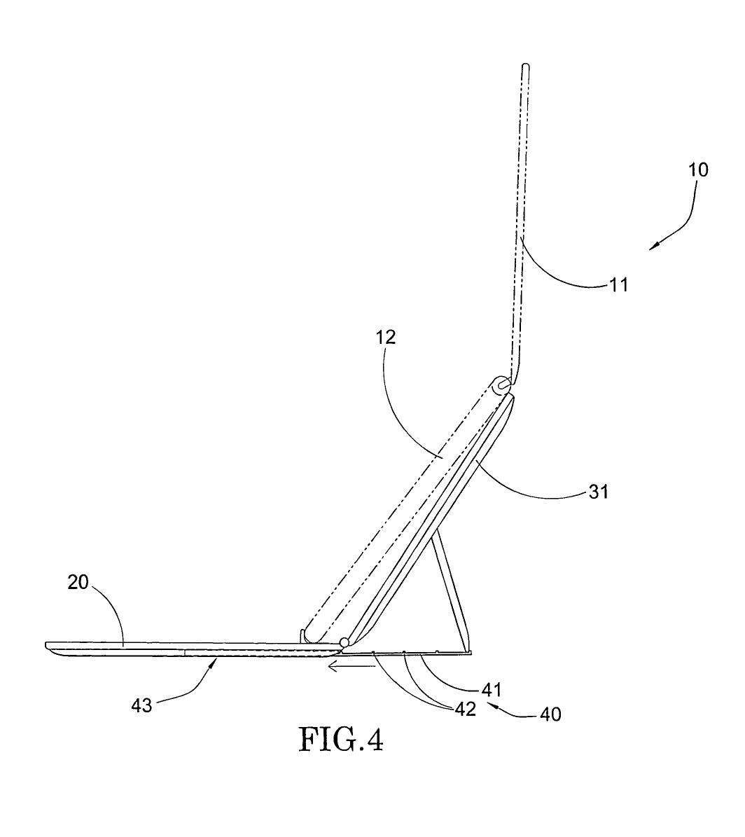

As shown in FIGS. 2 and 4, the bottom edge of the supporting panel 31 is pivotally coupled with the rear edge of the input device 20, wherein when the supporting panel 31 is folded at the operation position, the supporting side 301 of the supporting frame 30, i.e. the front side of the supporting panel 31, is inclinedly extended from the top side of the input device 20. Therefore, when the main panel 12 of the portable computer 10 is rested on the supporting side 301 of the supporting panel 31, the main panel 12 of the portable computer 10 is inclinedly supported on the working surface. In other words, the display panel 11 of the portable computer 10 will be elevated from the working surface. In addition, the input device 20 will be shifted away from display panel 11 of the portable computer 10 via the inclination of the supporting panel 31.

The supporting panel 30 further has a leg cavity 33 pivotally receiving the folding leg 32 thereat, wherein the leg cavity 33 is formed at the mid-portion of the supporting panel 30 and is extended from the bottom edge thereof such that the supporting panel 30 forms a U-shaped configuration to pivotally couple with the input device 20.

In addition, the folding leg 32 preferably has a planar structure having a top edge pivotally coupled with a top rim of the leg cavity 33. Accordingly, when the supporting frame 30 is folded at the folded position, the folding leg 32 is pivotally folded within the leg cavity 33 to form a flat surface with the supporting side 301 of the supporting panel 31. Therefore, the folding leg 32 will also be overlapped on the top side of the input device 20. When the supporting frame 30 is folded at the operation position, the folding leg 32 is pivotally folded out of the leg cavity 33 at a position that a bottom edge of the folding leg 32 stands on the working surface. In other words, the folding leg 32 also inclinedly stands on the working surface. Having a rigid triangular configuration among the supporting panel 31, the folding leg 32, and the working surface, as shown in FIG. 4, the portable computer 10 can be securely supported on the supporting frame 30 in a stable manner.

Accordingly, the supporting panel 31 is upwardly and pivotally folded from the input device 20 at the inclination angle while the folding leg 32 is rearwardly and pivotally folded from the supporting panel 31 to stand on the working surface so as to support the supporting panel 31 at the inclination angle. It is worth mentioning that the folding leg 32 will also support the weight of the portable computer 10 when the portable computer 10 is inclinedly supported on the supporting panel 31.

Accordingly, the inclination angle of the supporting panel 31 can be selectively adjusted. The portable computer operation station further an angle retainer 40 for selectively adjusting the inclination angle of the supporting panel 31, wherein the angle retainer 40 comprises a retainer platform 41 foldably coupled with the rear edge of the input device 20 and a plurality of angle adjusting members 42 spacedly formed on the retainer platform 41 and arranged in such a manner that the bottom edge of the folding leg 32 is selectively and detachably engaged with one of the angle adjusting members 42 to selectively adjust the inclination angle of the supporting panel 31.

The retainer platform 41 also has a planar structure for laying on the working surface, wherein the retainer platform 41 is rearwardly extended from the rear edge of the input device 20. The angle adjusting members 42 are elongated protrusions integrally and parallely protruded from the top side of the retainer platform 41. Therefore, when the bottom edge of the folding leg 32 is detachably engaged with angle adjusting member 42 positioned close to the rear edge of the input device 20, the inclination angle will be decreased, for example at 110° between the input device 20 and the supporting panel 31. Therefore, the supporting panel 31 will be close to an upright orientation. When the bottom edge of the folding leg 32 is detachably engaged with angle adjusting member 42 positioned close to the free edge of the retainer platform 41, the inclination angle will be increased, for example at 140° between the input device 20 and the supporting panel 31. Therefore, the supporting panel 31 will be at an inclined orientation.

As shown in FIG. 4, the angle retainer 40 further has a platform cavity 43 provided at a bottom side of the input device 20 to slidably couple with the retainer platform 41, such that when the retainer platform 41 is slid out of the platform cavity 43 to rearwardly extend from the rear edge of the input device 20, the bottom edge of the folding leg 32 is selectively and detachably engaged the respective angle adjusting member 42. Therefore, when the supporting frame 30 is folded at the folded position, the retainer platform 41 can be slid into the platform cavity 43 in a hidden manner to reduce the overall size of the portable computer operation station of the present invention. It is appreciated that the retainer platform 41 can be pivotally coupled with the input device 20 such that the retainer platform 41 is adapted to pivotally fold underneath the input device 20 and to receive in the platform cavity 43 in a hidden manner. Meanwhile, the retainer platform 41 can be pivotally folded out from the bottom side of the input device 20 to extend from the rear edge of the input device 20.

According to the preferred embodiment, the portable computer operation station further comprises one or more retention members 50 upwardly protruded from the input device 20 for biasing against a bottom edge of the main panel 12 of the portable computer 10 when the main panel 12 thereof is inclinedly supported by the supporting frame 30. As shown in FIGS. 1, 2 and 4, two retention members 50 are spacedly protruded from the top side of the input device 20 at a position close to the rear edge thereof. Accordingly, a holding gap is formed between the retention member 50 and the supporting panel 31, wherein a width of the holding gap is larger than a thickness of the main panel 12 of the portable computer 10. When the main panel 12 of the portable computer 10 is inclinedly supported at the supporting panel 31, the bottom edge of the main panel 12 will disposed at the holding gap and will bias against the retention members 50. Therefore, the retention members 50 will block the downward sliding movement of the portable computer 10 to prevent the main panel 12 thereof being slid down at the supporting panel 31. Preferably, the retention members 50 are protruded at the top side of the input device 20 at two side portions thereof respectively.

As it is mentioned above, the supporting panel 31 is folded flat on the input device 20 at the folded position. In order to prevent the downward folding movement of the supporting panel 31 being blocked by the retention members 50, one or more receiving cavities 51 are indently formed at the supporting panel 31 at the position correspondingly aligning with the retention members 50 respectively. Therefore, when the supporting panel 31 is folded flat on the input device 20, the retention members 50 are alignedly received at the receiving cavities 51 respectively, so as to ensure the supporting panel 31 being overlapped on the input device 20.

The portable computer operation station further comprises a computer peripheral link 60 for operatively linking the portable computer 10 with a peripheral computer device, wherein the computer peripheral link 60 comprises a plurality of peripheral communication ports 61 which can be provided at anywhere of the input device 20, preferably one or more outer peripheral sides of the input device 20, for detachably linking with one or more peripheral computer devices. The peripheral communication ports 61 are USB port, network connector, express card slot, VGA port, AC adapter connector, audio jacks, etc, wherein the peripheral communication portions 61 are preferably provided at two peripheral sides of the input device 20.

Accordingly, the computer peripheral link 60 is arranged for operatively linking the portable computer 10 when the portable computer 10 is supported at the portable computer operation station. Therefore, the computer peripheral link 60 is able to operatively connect with different peripheral computer devices for operatively linking to the portable computer 10 in order to expand the utility and connectivity of the portable computer 10 through the computer peripheral link 60 of the portable computer operation station.

The computer peripheral link 60 further comprises an air cooling unit 62 provided at the supporting side 301 of the supporting panel 31 for generating a cooling airflow towards the rear side of the main panel 12 of the portable computer 10 so as to enhance heat dissipation of the portable computer 10. As shown in FIGS. 2 and 4, the air cooling unit 62 comprises one or more fan units 621 supported at the supporting panel 31 and embedded in the supporting side 301 thereof for generating the cooling airflow towards the rear side of the main panel 12 of the portable computer 10 when the main panel 12 of the portable computer 10 is rested on the supporting side 301 of the supporting panel 31. The cooling unit 62 can further comprise a compartment 622 provided at the supporting panel 31 for receiving at least a cable such as USB cable so as to electrically connect the fan units 621 to a USB socket of the portable computer 10 for power supply to the fan units 621. Alternatively, it is appreciated that one or more batteries can be installed inside cooling unit 62 so that the fan units 621 can draw electrical power from the batteries in the cooling unit 62, or that the fan units 621 can draw electrical power from the portable computer 10 where the fan unit 621 can be electrically connected to the portable computer 10 through one of the peripheral communication ports 61 via an electric cable such as USB cable.

According to the preferred embodiment, the portable computer operation station of the present invention can be set up to offer a comfortable and ergonomically safe environment for the user by upwardly and pivotally folding the supporting panel 31 from the input device 20 to inclinedly support the main panel 12 of the portable computer 10 and by elevating the display device 11 from the working surface via the supporting frame 30 such that the portable computer operation station of the present invention can be stably supported the portable computer 10 on the working surface.

In addition, since the input device 20 is positioned away from the portable computer 10, the distance between the input device 20 and the display panel 11 of the portable computer 10 will be increased, such that the display panel 11 will be about an arm length from the user. The user is able to carry the portable computer operation station with the portable computer 10 together, wherein the portable computer operation station is considered as a portable workstation for enabling the user to set up the portable computer operation station at any working surface for offering a comfortable and ergonomically safe environment for the user.

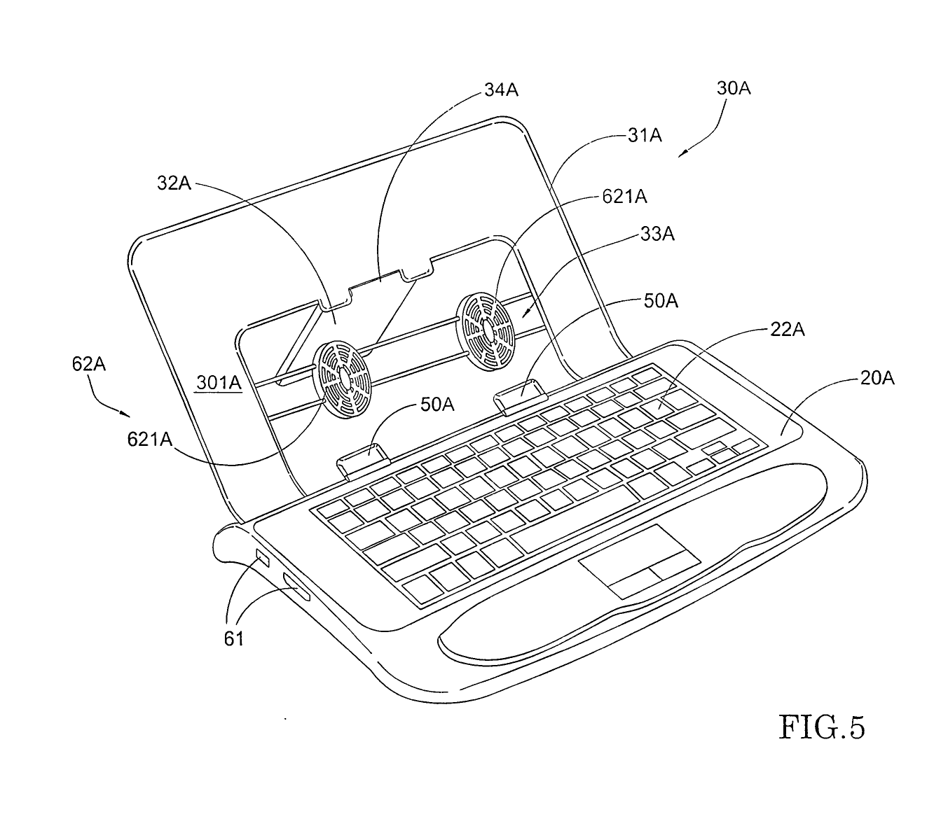

As shown in FIG. 5, a portable computer operation station of a second embodiment illustrates an alternative mode of the first embodiment, wherein the structural configuration of the portable computer operation station of the second embodiment is the same as that of the first embodiment. In other words, the second embodiment is a modification of the first embodiment.

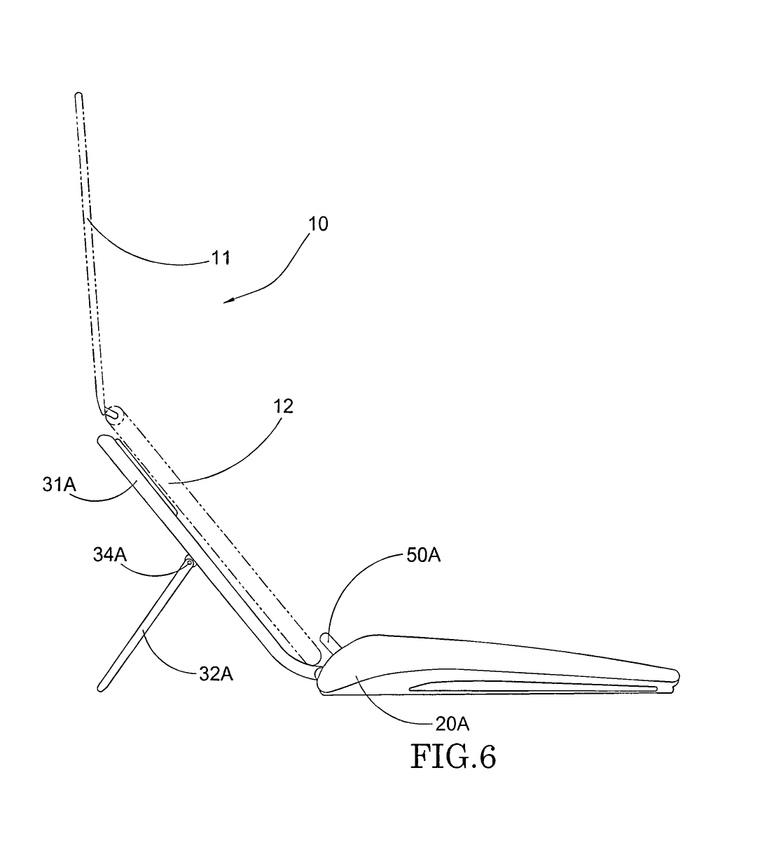

As shown in FIGS. 5 to 7, the input device 20A is modified that the input panel 21A has a trapezoid cross section defining a top inclined input side in a sloped downward manner for ergonomically fitting a hand position of a user in a neutral position while fingers of the user are placed on keys of the keyboard 22A on the top inclined input side.

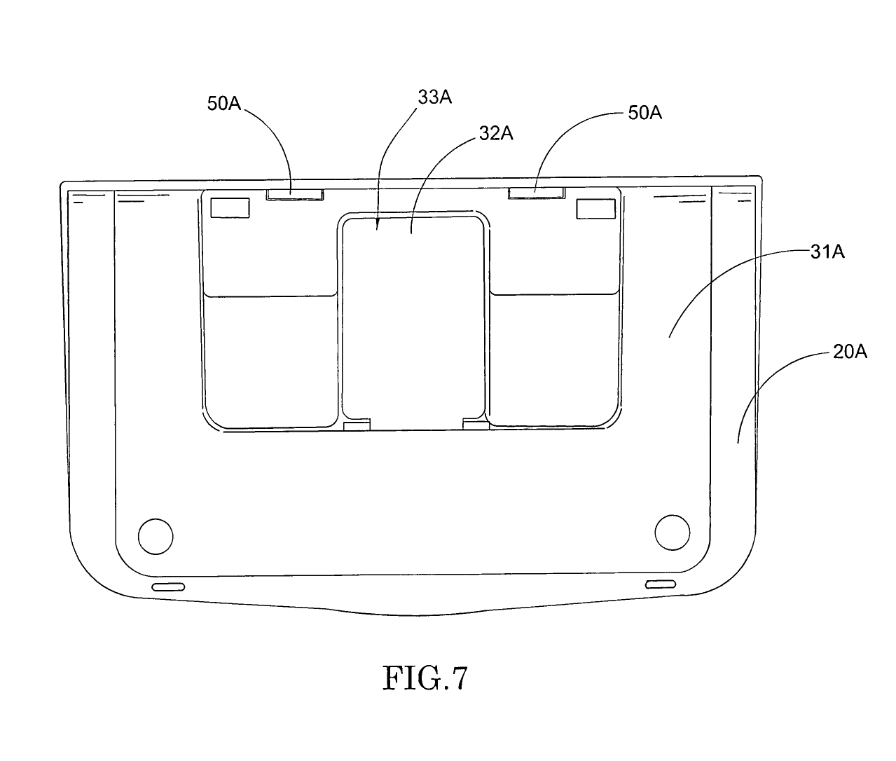

Correspondingly, the supporting panel 31A of the supporting frame 30A has a predetermined curvature that the supporting panel 31A can be overlapped on the top inclined input side of the input device 20A, as shown in FIG. 7.

Similar to the first embodiment, the folding leg 32A is pivotally coupled with the supporting panel 31 A and arranged in such a manner that when the supporting panel 31 A is pivotally and upwardly folded from the input device 20A for inclinedly supporting the main panel 12 of the portable computer 10, the folding leg 32A is pivotally and outwardly folded for standing at the working surface to retain the supporting panel 31A at the inclination angle.

In particular, the folding leg 32A is pivotally coupled with a top rim of the leg cavity 33A. Accordingly, when the supporting frame 30A is folded at the folded position, the folding leg 32A is pivotally folded within the leg cavity 33A to form a flat surface with the supporting side 301A of the supporting panel 31A. Therefore, the folding leg 32A will also be overlapped on the top side of the input device 20A. When the supporting frame 30A is folded at the operation position, the folding leg 32A is pivotally folded out of the leg cavity 33A at a position that a bottom edge of the folding leg 32A stands on the working surface.

In order to retain the supporting panel 31A at the inclination angle, the folding leg 32A is pivotally coupled with a top rim of the leg cavity 33A via an angle limiting hinge 34A. In other words, the angle limiting hinge 34A will function as the angle retainer 40 of the first embodiment.

Accordingly, the angle limiting hinge 34A is arranged to block the further pivot movement of the folding leg 32A. Therefore, the folding leg 32A can only be pivotally folded between a first position that the folding leg 32A is pivotally folded within the leg cavity 33A to form a flat surface with the supporting side 301A of the supporting panel 31A and a second position that the folding leg 32A is pivotally folded out of the leg cavity 33A at a predetermined folding angle between the folding leg 32A and the supporting panel 31A. Preferably, the supporting panel 31A at the inclination angle of 120°.

Another modification of the second embodiment is that the retention members 50A are upwardly protruded from the input device 20A for biasing against the bottom edge of the main panel 12 of the portable computer 10 when the main panel 12 thereof is inclinedly supported by the supporting frame 30A. The retention members 50A are pivotally coupled at the input device 20A that the retention members 50A are pivotally folded flat on the input device 20A and are adapted for pivotally folding upward from the input device 20A to form the holding gap. Therefore, when the retention members 50A are pivotally folded upward, the retention members 50A will block the downward sliding movement of the portable computer 10 to prevent the main panel 12 thereof being slid down at the supporting panel 31A.

In addition, one or more fan units 621A of the air cooling unit 62A can be an external add-on device that the fan units 621A can be detachably coupled at the rear side of the supporting panel 31A to align with the main panel 12 of the portable computer 10 when the portable computer 10 is supported at the supporting panel 31A.

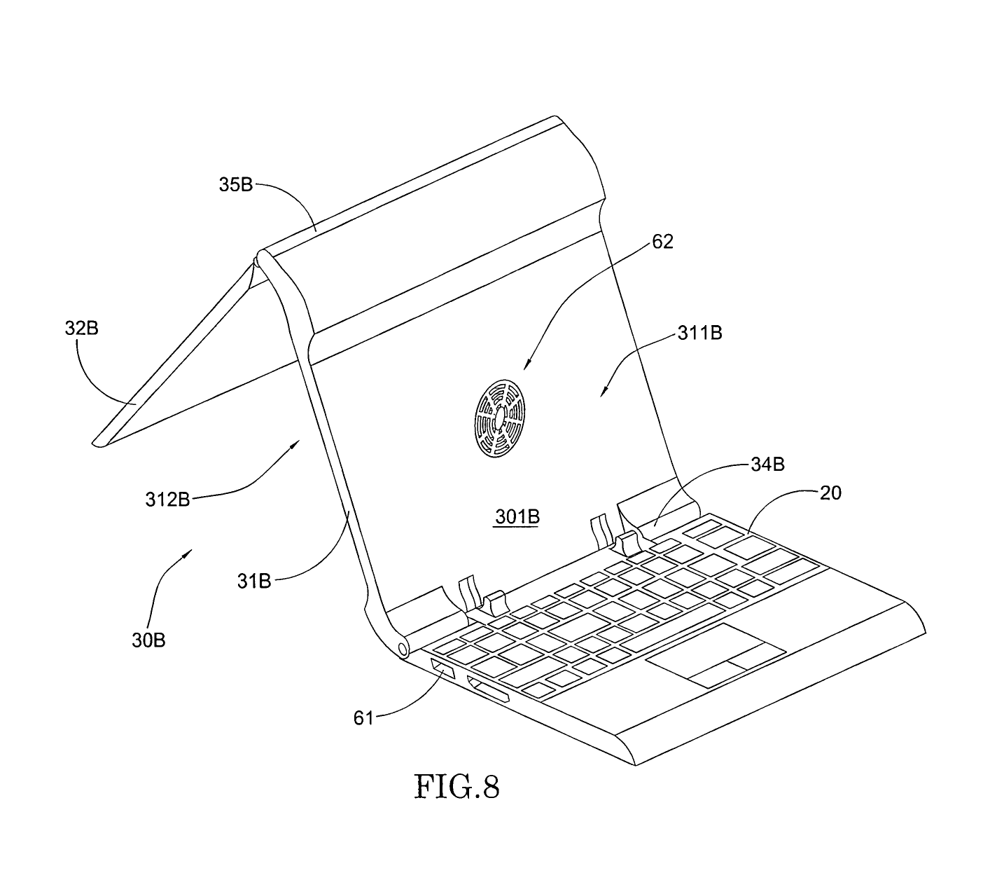

As shown in FIG. 8, a portable computer operation station of a third embodiment illustrates an alternative mode of the first embodiment to show a modification of the supporting frame 30B.

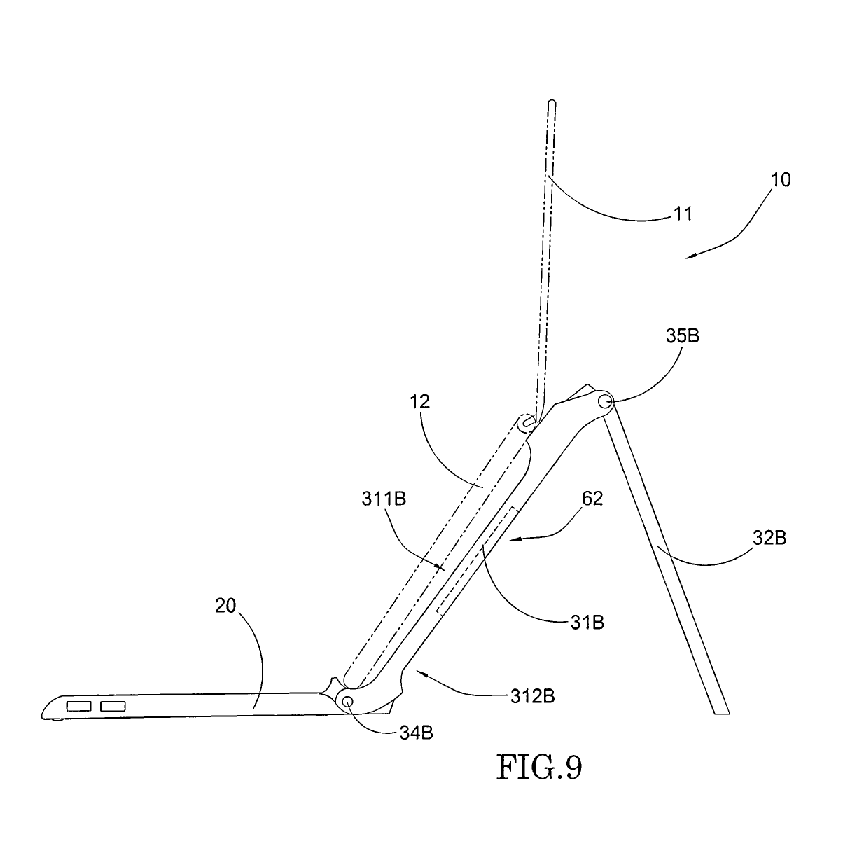

As shown in FIGS. 8 to 10, the supporting frame 30B comprises a supporting panel 31B pivotally coupled with the input device 20 edge-to-edge, and a folding leg 32B pivotally coupled with the supporting panel 31B and arranged in such a manner that when the supporting panel 31B is pivotally and upwardly folded from the input device 20 for inclinedly supporting the main panel 12 of the portable computer 10, the folding leg 32B is pivotally and outwardly folded for standing at the working surface to retain the supporting panel 31B at the inclination angle.

Accordingly, the bottom edge of the supporting panel 31B is pivotally coupled with the rear edge of the input device 20, wherein when the supporting panel 31B is folded at the operation position, the supporting side 301B of the supporting frame 30B, i.e. the front side of the supporting panel 31B, is inclinedly extended from the top side of the input device 20. Therefore, when the main panel 12 of the portable computer 10 is rested on the supporting side 301B of the supporting panel 31B, the main panel 12 of the portable computer 10 is inclinedly supported on the working surface. In other words, the display panel 11 of the portable computer 10 will be elevated from the working surface. In addition, the input device 20 will be shifted away from display panel 11 of the portable computer 10 via the inclination of the supporting panel 31B.

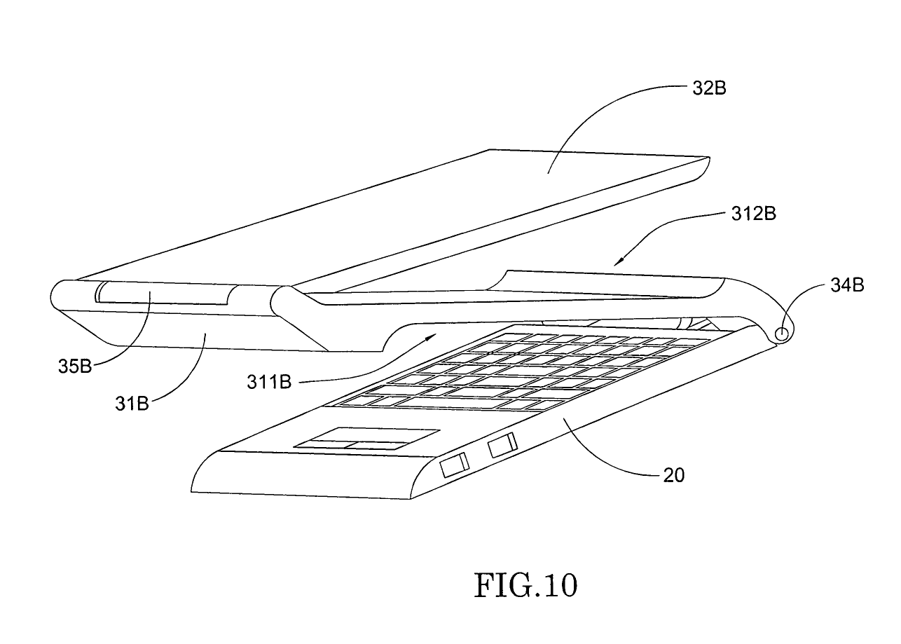

The top edge of the folding leg 32B is pivotally coupled with the top edge of the supporting panel 31B, wherein when the folding leg 32B is pivotally and outwardly folded from the supporting panel 31B, the bottom edge of the folding leg 32B will stand at the working surface to retain the supporting panel 31B at the inclination angle. In other words, the input device 20, the supporting panel 31B, and the folding leg 32B are pivotally connected in a tri-fold manner that the supporting panel 31B is pivotally folded to be sandwiched between the input device 20 and the folding leg 32B at said folded position, as shown in FIG. 10.

It is appreciated that the bottom edge of the supporting panel 31B is pivotally coupled with the rear edge of the input device 20 via a first angle limiting hinge 34B while the top edge of the folding leg 32B is pivotally coupled with the top edge of the supporting panel 31B via a second angle limiting hinge 35B. The first and second angle limiting hinges 34B, 35B are arranged to block the further pivot movement of the supporting panel 31B and the folding leg 32B respectively. Therefore, the supporting panel 31B can only be pivotally and upwardly folded from the input device 20 at the predetermined inclination angle via the first angle limiting hinge 34B while the folding leg 32B can only be pivotally and outwardly folded from the supporting panel 31B at a predetermined folding angle between the folding leg 32B and the supporting panel 31B.

According to the third embodiment, the supporting panel 31B further has a first cavity 311B indented at the supporting side 301B thereof to receive the input device 20 in the first cavity 311B, and a second cavity 312B indented at the opposed rear side to receive the folding leg 32B when the input device 20, the supporting panel 31B, and the folding leg 32B are tri-folded in the folded position, as shown in FIG. 10, so as to reduce the overall thickness of the portable computer operation station at the folded position.

It is appreciated that the input device 20 can be configured to have a trapezoid cross section defining a top inclined input side in a sloped downward manner while the input device 20 can be received in the first cavity 311B of the supporting panel 31B to cover the top inclined input side of the input device 20 by the supporting side 301B of the supporting panel 31B.

In addition, the computer peripheral link 60 can be provided at the supporting panel 31B that peripheral communication ports 61 provided at an outer peripheral side of the input device 20 while the air cooling unit 62 is provided at the supporting side 301B of the supporting panel 31B.

The retention members 50 are pivotally coupled at the input device 20 that said retention members 50 are pivotally folded flat on the input device 20 and are adapted for pivotally folding upward for biasing against the bottom edge of the main panel 12 of the portable computer 10.

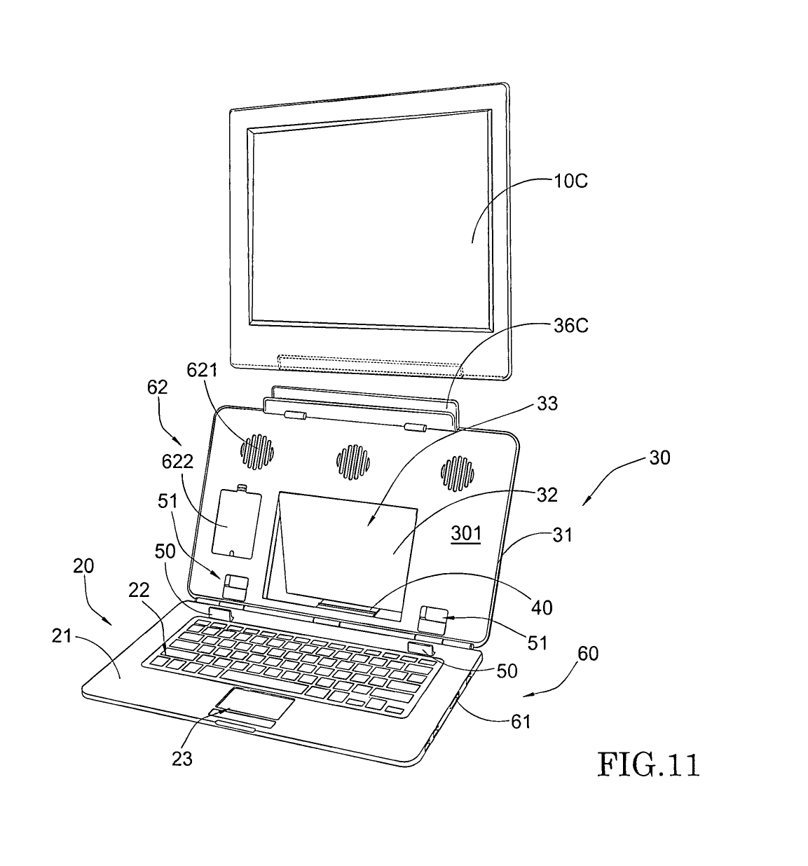

As shown in FIG. 11, a portable computer operation station of a fourth embodiment further illustrates an alternative mode of the first embodiment to show a modification of the supporting frame 30C incorporating with a tablet computer.

Accordingly, the portable computer 10C is embodied as a tablet computer, such as “iPad” of Apple, “Playbook” of Blackberry or “TouchPad” of HP, having touch screen ability, wherein the display panel 11 is integrated with the main panel 12 to form a single tablet panel of the tablet computer.

The supporting frame 30 can be the supporting frame of the first embodiment as shown in FIG. 2 and further comprises a display adapter 36C provided at a top edge of the supporting panel 31 wherein the tablet computer is detachably coupled with the supporting frame 30 via a display adapter 36C. In order words, the portable computer operation station as illustrated in FIG. 11 of the fourth embodiment can work with both the notebook computer as well as the tablet. Also, it is worth mentioning that the supporting frame 30 can also simply include a supporting panel 31 without the cooling fan 621 and compartment 622 provided thereon but further comprises the display adapter 36C. It is worth mentioning that the tablet computer can also directly and inclinedly place on the supporting side 301 of the supporting panel 31 as shown in FIG. 11.

As shown in FIG. 11, the display adapter 36C, preferably having a U-shaped cross section, is provided at the top edge of the supporting panel 31 to detachably couple with the tablet computer. In addition, the display adapter 36C also forms as the pivot hinge that when the tablet computer is detachably coupled at the display adapter 36C, the tablet computer is adapted to pivotally fold and overlap on the supporting panel 31. In other words, the display adapter 36C forms as a detachable coupler and the pivot hinge to enable the tablet computer being detachably coupled and pivotally folded with the supporting panel 31 so as to elevate the tablet computer from the working surface. In addition, the input device 20 is operatively linked to the tablet computer through wireless connection such as “Bluetooth” or infrared connection. Alternatively, it is appreciated that the input device 20 can also be operatively linked to the tablet computer through wire connection such as USB cable connection.

Therefore, the portable computer operation station of the present invention can be an individual standalone unit as a docking station to incorporate with any existing portable computer such as the notebook or tablet computer by detachably attaching the portable computer to the portable computer operation station which can be functioned as a work station that is generally connected with the projector, printer, speakers, DSL cable, DVD or CD reader, SD or other smart card reader, game console, external hard drive, and other peripheral computer devices via the peripheral communication ports 61 provided in the portable computer operation station of the present invention, so that whenever the portable computer is mounted or docked on the portable computer operation station, necessary computer accessories are connected with the portable computer.

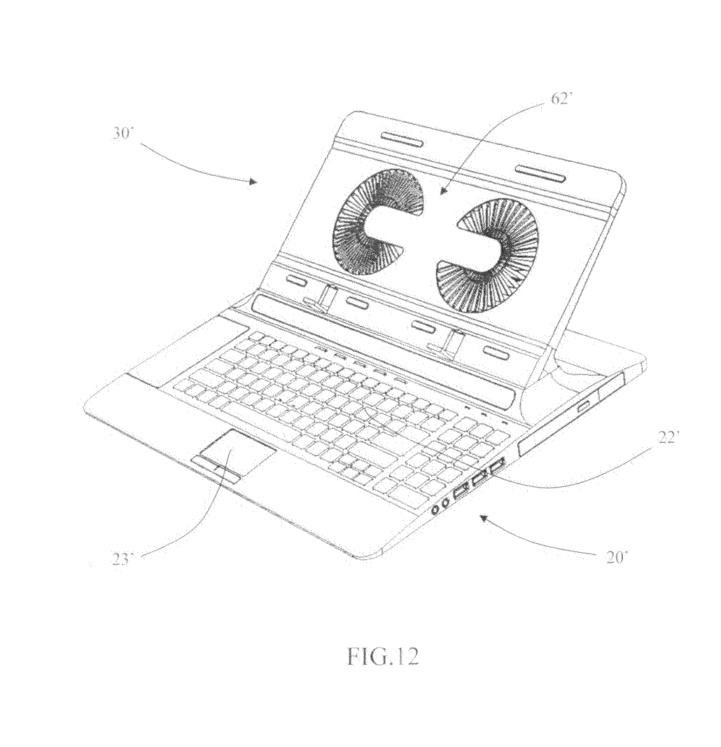

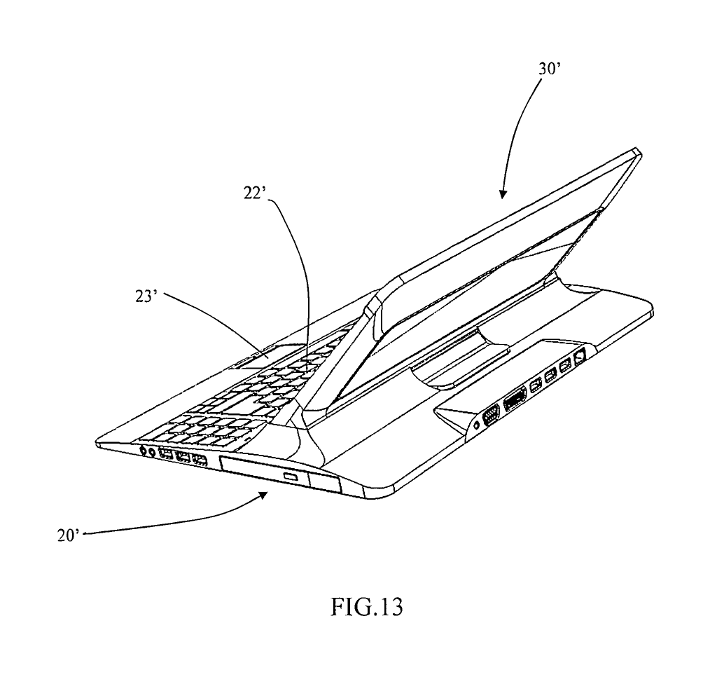

As shown in FIGS. 12 and 13, a fifth embodiment of the portable computer operation station for a portable computer is illustrated, which also comprises an input device 20′ and a supporting frame 30′ constructed as illustrated in the above four embodiments, wherein the alternative modification is that the input device 20′ and the supporting frame 30′ are constructed as an integral body that the supporting frame 30′ is upwardly and rearwardly extended from the input device 20′. Similarly, the input device 20′ comprises a keyboard 22′ and a pointing device 23′ thereon and the supporting frame 30′ comprises a cooling unit 62′. According to this fifth embodiment, the portable computer operation station is embodied to comprises a total of eight 2.0 USB ports provided along the right side and rear side thereof, a card reader provided at the left side thereof which supports as many as eight kinds of memory card, including SC/MINISD/TF/CF/SM/MS/MMC/MMC micro, a DSL cable port provided at the rear side thereof, a disc ROM, supporting CD/VCD/DVD&RW, provided at right side thereof, a VGA port for projector provided at the rear side thereof, audio ports provided at right side thereof for connecting with speakers (such as 2.0 or more speaker function) or earphone (3.5 mm or 2 mm earphone), a printer port provided at the rear side thereof, a Skype phone set, including a Skype telephone set or USB phone, provided at a left portion of the keyboard 22′, and a power port for connecting to a power source provided at the rear side thereof. In addition, the cooling unit 62 comprises at least a 5V cooling fan provided inside the supporting frame 30′.

In other words, all the distinctive features of the first to fifth embodiments are interchangeable. One skilled in the art will understand that the embodiment of the present invention as shown in the drawings and described above is exemplary only and not intended to be limiting. It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A portable computer operation station for a portable computer having a main panel and a display panel; comprising:
an input device adapted for resting on a working surface and for operatively linking to said portable computer; and
a supporting frame foldably coupled with said input device to move between a folded position and an operation position, wherein at said folded position, said supporting frame is folded to overlap on said input device to form a compact planar structure, and at said operation position, said supporting frame is folded at an inclination angle with respect to said input device for inclinedly supporting said main panel of said portable computer at said supporting frame so as to elevate said display panel of said portable computer and to offer an extended length between said display panel of said portable computer and said input device.

2. The portable computer operation station, as recited in claim 1, wherein said supporting frame comprises a supporting panel pivotally coupled with said input device edge-to-edge, and a folding leg pivotally coupled with said supporting panel and arranged in such a manner that when said supporting panel is pivotally and upwardly folded from said input device for supporting said main panel of said portable computer, said folding leg is pivotally and outwardly folded for standing at said working surface to retain said supporting panel at said inclination angle.

3. The portable computer operation station, as recited in claim 2, wherein said supporting panel has a supporting side for supporting said main panel of said portable computer thereon, and a leg cavity pivotally receiving said folding leg thereat such that when said supporting frame is folded at said folded position, said folding leg is pivotally folded within said leg cavity to form a flat surface with said supporting side of said supporting panel, and when said supporting frame is folded at said operation position, said folding leg is pivotally folded out of said leg cavity for inclinedly standing on said working surface.

4. The portable computer operation station, as recited in claim 1, further comprising one or more retention members upwardly protruded from said input device for biasing against a bottom edge of said main panel of said portable computer when said main panel thereof is inclinedly supported by said supporting frame.

5. The portable computer operation station, as recited in claim 3, further comprising one or more retention members upwardly protruded from said input device for biasing against a bottom edge of said main panel of said portable computer when said main panel thereof is inclinedly supported by said supporting frame.

6. The portable computer operation station, as recited in claim 4, wherein said retention members are pivotally coupled at said input device that said retention members are pivotally folded flat on said input device and are adapted for pivotally folding upward for biasing against said bottom edge of said main panel of said portable computer.

7. The portable computer operation station, as recited in claim 6, wherein said retention members are pivotally coupled at said input device that said retention members are pivotally folded flat on said input device and are adapted for pivotally folding upward for biasing against said bottom edge of said main panel of said portable computer.

8. The portable computer operation station, as recited in claim 2, further comprising an angle retainer for selectively adjusting said inclination angle of said supporting panel, wherein said angle retainer comprises a retainer platform foldably coupled with a rear edge of said input device and a plurality of angle adjusting members spacedly formed on said retainer platform and arranged in such a manner that a bottom edge of said folding leg is selectively and detachably engaged with one of said angle adjusting members to selectively adjust said inclination angle of said supporting panel.

9. The portable computer operation station, as recited in claim 3, further comprising an angle retainer for selectively adjusting said inclination angle of said supporting panel, wherein said angle retainer comprises a retainer platform foldably coupled with a rear edge of said input device and a plurality of angle adjusting members spacedly formed on said retainer platform and arranged in such a manner that a bottom edge of said folding leg is selectively and detachably engaged with one of said angle adjusting members to selectively adjust said inclination angle of said supporting panel.

10. The portable computer operation station, as recited in claim 7, further comprising an angle retainer for selectively adjusting said inclination angle of said supporting panel, wherein said angle retainer comprises a retainer platform foldably coupled with a rear edge of said input device and a plurality of angle adjusting members spacedly formed on said retainer platform and arranged in such a manner that a bottom edge of said folding leg is selectively and detachably engaged with one of said angle adjusting members to selectively adjust said inclination angle of said supporting panel.

11. The portable computer operation station, as recited in claim 8, wherein said angle retainer further has a platform cavity provided at a bottom side of said input device to slidably couple with said retainer platform, such that when said retainer platform is slid out of said platform cavity to rearwardly extend from said rear edge of said input device, said bottom edge of said folding leg is selectively and detachably engaged said respective angle adjusting member.

12. The portable computer operation station, as recited in claim 9, wherein said angle retainer further has a platform cavity provided at a bottom side of said input device to slidably couple with said retainer platform, such that when said retainer platform is slid out of said platform cavity to rearwardly extend from said rear edge of said input device, said bottom edge of said folding leg is selectively and detachably engaged said respective angle adjusting member.

13. The portable computer operation station, as recited in claim 10, wherein said angle retainer further has a platform cavity provided at a bottom side of said input device to slidably couple with said retainer platform, such that when said retainer platform is slid out of said platform cavity to rearwardly extend from said rear edge of said input device, said bottom edge of said folding leg is selectively and detachably engaged said respective angle adjusting member.

14. The portable computer operation station, as recited in claim 2, wherein said supporting frame further comprises an air cooling unit provided at said supporting side of said supporting panel for generating a cooling airflow towards a rear side of said main panel of said portable computer so as to enhance heat dissipation of said portable computer.

15. The portable computer operation station, as recited in claim 5, wherein said supporting frame further comprises an air cooling unit provided at said supporting side of said supporting panel for generating a cooling airflow towards a rear side of said main panel of said portable computer so as to enhance heat dissipation of said portable computer.

16. The portable computer operation station, as recited in claim 13, wherein said supporting frame further comprises an air cooling unit provided at said supporting side of said supporting panel for generating a cooling airflow towards a rear side of said main panel of said portable computer so as to enhance heat dissipation of said portable computer.

17. The portable computer operation station, as recited in claim 1, wherein said input device has a trapezoid cross section defining a top inclined input side in a sloped downward manner for ergonomically fitting a hand position of a user in a neutral position while fingers of said user are placed on keys on said top inclined input side.

18. The portable computer operation station, as recited in claim 5, wherein said input device has a trapezoid cross section defining a top inclined input side in a sloped downward manner for ergonomically fitting a hand position of a user in a neutral position while fingers of said user are placed on keys on said top inclined input side.

19. The portable computer operation station, as recited in claim 16, wherein said input device has a trapezoid cross section defining a top inclined input side in a sloped downward manner for ergonomically fitting a hand position of a user in a neutral position while fingers of said user are placed on keys on said top inclined input side.

20. The portable computer operation station, as recited in claim 2, wherein said input device, said supporting panel, and said folding leg are pivotally connected in a tri-fold manner that said supporting panel is pivotally folded to be sandwiched between said input device and said folding leg at said folded position.

21. The portable computer operation station, as recited in claim 20, wherein said supporting panel has a first cavity indented at a supporting side thereof to receive said input device in said first cavity, and a second cavity indented at an opposed rear side to receive said folding leg when said input device, said supporting panel, and said folding leg are tri-folded in said folded position.

22. The portable computer operation station, as recited in claim 21, further comprising one or more retention members upwardly protruded from said input device for biasing against a bottom edge of said main panel of said portable computer when said main panel thereof is inclinedly supported by said supporting frame.

23. The portable computer operation station, as recited in claim 22, wherein said retention members are pivotally coupled at said input device that said retention members are pivotally folded flat on said input device and are adapted for pivotally folding upward for biasing against said bottom edge of said main panel of said portable computer.

24. The portable computer operation station, as recited in claim 23, wherein said supporting frame further comprises an air cooling unit provided at said supporting side of said supporting panel for generating a cooling airflow towards a rear side of said main panel of said portable computer so as to enhance heat dissipation of said portable computer.

25. The portable computer operation station, as recited in claim 23, wherein said input device has a trapezoid cross section defining a top inclined input side in a sloped downward manner for ergonomically fitting a hand position of a user in a neutral position while fingers of said user are placed on keys on said top inclined input side.
